(19) United States
(12) Patent Application Publication
(10) Pub. No.: US 2012/0210125 A1
(43) Pub. Date: Aug. 16, 2012

(54) ENCRYPTED TRAFFIC TEST SYSTEM

(75) Inventors: Tomohiro Shigemoto, Ebina (JP); Hirofumi Nakakoji, Yokohama (JP); Tetsuro Kito, Yokohama (JP); Hisashi Umeki, Kawasaki (JP); Satoshi Takemoto, Chigasaki (JP); Tadashi Kaji, Yokohama (JP); Satoshi Kai, Yokohama (JP)

(73) Assignee: HITACHI, LTD., Tokyo (JP)

(21) Appl. No.: 13/368,620

(22) Filed: Feb. 8, 2012

(30) Foreign Application Priority Data
Feb. 10, 2011 (JP) 2011-027327

(51) Int. Cl. H04L 29/06

(52) U.S. Cl. 713/161

(57) ABSTRACT

An encrypted traffic test system is disclosed which tests whether or not traffic involving packets over a network is encrypted, the encrypted traffic test system including: a test data acquisition portion configured to receive each of the packets on the network so as to acquire test data from the received packet; an encrypted traffic test portion configured to evaluate the test data acquired by the test data acquisition portion for randomness using a random number testing scheme and, if the test data is evaluated to have randomness, to further determine that the traffic involving the packets including the test data is encrypted traffic; and a test result display portion configured to display a test result from the encrypted traffic test portion on a test result display screen.

### INCORPORATION BY REFERENCE

The present application claims priority from Japanese application serial No. 2011-027327, filed on Feb. 10, 2011, the entire contents of which are hereby incorporated by reference into this application.

### BACKGROUND

The present invention relates to a technique for testing whether or not traffic on a network is encrypted.

One way of utilizing computers based on the Internet is known as cloud computing (simply called “cloud” hereunder where appropriate). This is a mode in which the services offered by servers located on the network are utilized by people who are not aware of these servers. Traditionally, computer users have possessed and managed the hardware, software and data of their computers. In cloud computing, by contrast, the providers in possession of the servers offering services retain and manage the hardware, software and data of the equipment involved. By making use of cloud computing, the user enjoys the advantage of cutting down on expenses in purchasing computers and getting freed from the chores of managing data.

Cloud-based services are being offered extensively today. These offerings are in the process of constituting a basic infrastructure that supports people's lives and economic activities.

Cloud computing has one major disadvantage: it is difficult for cloud users to know the status of each of the components making up a given system (servers, networks, storage, etc.) because the structures of the components may be dynamically changed over time or the configuration of the system may remain unknown to the users. This is a major impediment preventing potential users from resorting to cloud computing or storing important data in the cloud.

The need has thus been recognized for establishing a monitoring technology whereby information about the security of the components making up the system is collected and analyzed in order to grasp their security status in real time. Such a technology can constitute an important factor encouraging cloud users to receive cloud-based service offerings safely and securely.

Given such developments, attempts have been proposed to test whether or not network traffic is encrypted. For example, Japanese Published Unexamined Patent Application No. 2003-124924 describes an apparatus which includes an encryption portion, a decryption portion and a random number testing portion and which checks the safety of encrypted data (i.e., whether data is encrypted or not) by detecting the randomness of encrypted data. As another example, Japanese Published Unexamined Patent Application No. 2007-36834 depicts an apparatus that attaches to encrypted outgoing data a flag (data) indicating that the data in question is encrypted so that the transmitted or received data may be detected to be encrypted.

### SUMMARY OF THE INVENTION

According to the apparatus described in Japanese Published Unexamined Patent Application No. 2003-124924, all data encrypted by the encryption portion is input to the random number testing portion. If this technique is applied to packets flowing over the network, unencrypted data parts such as packet headers are also subjected to random number testing. This can degrade the accuracy of the random number testing process.

One disadvantage of the apparatus depicted in Japanese Published Unexamined Patent Application No. 2007-36834 is that it needs auxiliary data such as the flag for determining whether data is encrypted or not.

The present invention has been made in view of the above circumstances and provides a system that tests accurately whether the traffic on a network is encrypted without recourse to auxiliary data such as flags, and displays the result of the test.

According to one disclosed embodiment, there is provided an encrypted traffic test system including: a test data acquisition portion configured to receive each of packets on a network so as to acquire test data from the received packet; an encrypted traffic test portion configured to evaluate the acquired test data for randomness using a random number testing scheme and, if the test data is evaluated to have randomness, to further determine that the traffic involving the packets including the test data is encrypted traffic; and a test result display portion configured to display a test result.

In one referred structure of the encrypted traffic test system, the test data acquisition portion may acquire the test data based on a predetermined test data acquisition policy.

In another preferred structure of the encrypted traffic test system, the encrypted traffic test portion may evaluate the randomness of the test data in accordance with a random number level of the test data based on at least one random number testing result.

In a further preferred structure of the encrypted traffic test system, the test result display portion may display the test result based on the random number level and on a test result display policy.

According to the encrypted traffic test system disclosed as outlined above, it is possible to test whether or not the traffic regarding each of predetermined test targets is encrypted.

### BRIEF DESCRIPTION OF THE DRAWINGS

FIG. 1 is a schematic view showing a typical network configuration including an encrypted traffic test system as a first embodiment;

FIG. 2 is a schematic view showing a typical structure of a test data acquisition apparatus;

FIG. 3 is a tabular view showing an example of test data acquisition policy data;

FIG. 4 is a schematic view showing a typical structure of an encrypted traffic test apparatus;

FIG. 5 is a schematic view showing a typical structure of a test result display apparatus;

FIG. 6 is a tabular view showing an example of test result display policy data;

FIG. 7A is a schematic view showing a typical test result display screen;

FIG. 7B is a schematic view showing another typical test result display screen;

FIG. 8 is a flowchart of an acquisition process;

FIG. 9 is a flowchart of a test process;

FIG. 10 is a flowchart of a display process;

FIG. 11 is a schematic view showing a modification of the network configuration including the encrypted traffic test system;

FIG. 12 is a schematic view showing another modification of the network configuration including the encrypted traffic test system;

FIG. 13 is a schematic view showing a typical network configuration including an encrypted traffic test system as a second embodiment;

FIG. 14 is a schematic view showing a typical structure of a countermeasure execution apparatus as part of the second embodiment;

FIG. 15 is a tabular view showing an example of countermeasure execution policy data of the second embodiment;

FIG. 16 is a flowchart of a countermeasure execution program of the second embodiment;

FIG. 17 is a schematic view showing a typical network configuration including an encrypted traffic test system as a third embodiment;

FIG. 18 is a tabular view showing an example of test result data of the third embodiment;

FIG. 19A is a schematic view showing a typical test result display screen of the third embodiment; and

FIG. 19B is a schematic view showing another typical test result display screen of the third embodiment.

### DESCRIPTION OF THE PREFERRED EMBODIMENTS

Where the data part (packet data, payload) of a packet flowing over a network is encrypted, the packet data appears to be a featureless random number sequence. Random number testing may then be carried out on the packet data to see whether or not the traffic involving the packet is encrypted. However, subjecting the entire packet (including the packet header and payload) to random number testing can degrade the accuracy of the tests. That is because unencrypted parts of the packet such as the header are mixed with the data part targeted for random number testing.

Incidentally, the transmission and reception of a series of packets between terminals will be generically called “traffic” in connection with the preferred embodiments of the present invention to be described hereunder.

The embodiments involve selecting test data of the target to be tested for randomness and subjecting the selected test data to a plurality of types of random number testing in order to improve the accuracy of the test on encrypted traffic. The first embodiment will emphasize that aspect of the invention and will be discussed with regard to test data acquisition, encrypted traffic tests, and test result display.

The second embodiment will be explained with emphasis on the traffic control based on test results.

The third embodiment will be described with emphasis on the storage of test results so that past test results may be referenced later.

### First Embodiment

The first embodiment to be explained below is an encrypted traffic test system that includes a test data acquisition apparatus for acquiring test target data from the traffic on a network, an encrypted traffic test apparatus for testing whether the acquired data is encrypted, and a test result display apparatus for displaying test results.

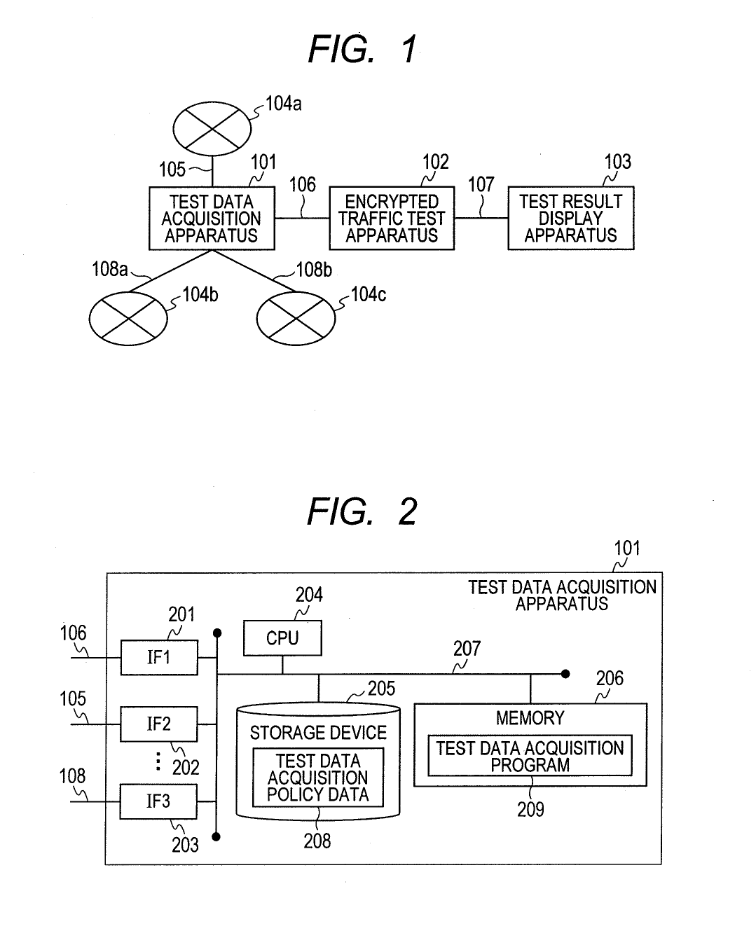

FIG. 1 shows a typical network configuration including the encrypted traffic test system working as the first embodiment that tests encrypted traffic. As shown in FIG. 1, the encrypted traffic test system is structured to include a test data acquisition apparatus 101, an encrypted traffic test apparatus 102, and a test result display apparatus 103.

The ensuing description will be made on the assumption that the above-described apparatuses acquire test data, perform encrypted traffic tests on the test data, and display test results respectively. Alternatively, however, a single apparatus may take on the above-mentioned encrypted traffic tests according to the communication traffic going through the network, for example. The test data acquisition apparatus 101 is the first to be discussed below.

The test data acquisition apparatus 101 connected to a network 104 acquires test data from each packet passing therethrough based on a predetermined test data acquisition policy, and outputs the acquired test data onto a communication path 106. The details of the test data acquisition policy will be discussed later in reference to FIG. 3.

The network 104 may be an intranet, the Internet, or any suitable communication network connected to these networks. At least one terminal is connected to the network 104 and is typically involved in the traffic typically involving web access and file transfers. Communication paths 105, 106, 107 and 108 are information transmission media such as bus and cables.

The encrypted traffic test apparatus 102 receives test data flowing on the communication path 106, calculates an encryption level of the received test data, and transmits a result of the test onto the communication path 107.

The encrypted traffic test apparatus 102 performs encrypted traffic tests on the test data acquired by the test data acquisition apparatus 101. However, if the encrypted traffic test apparatus 102 possesses sufficient capabilities, the apparatus 102 may also acquire the test data in addition to carrying out the tests.

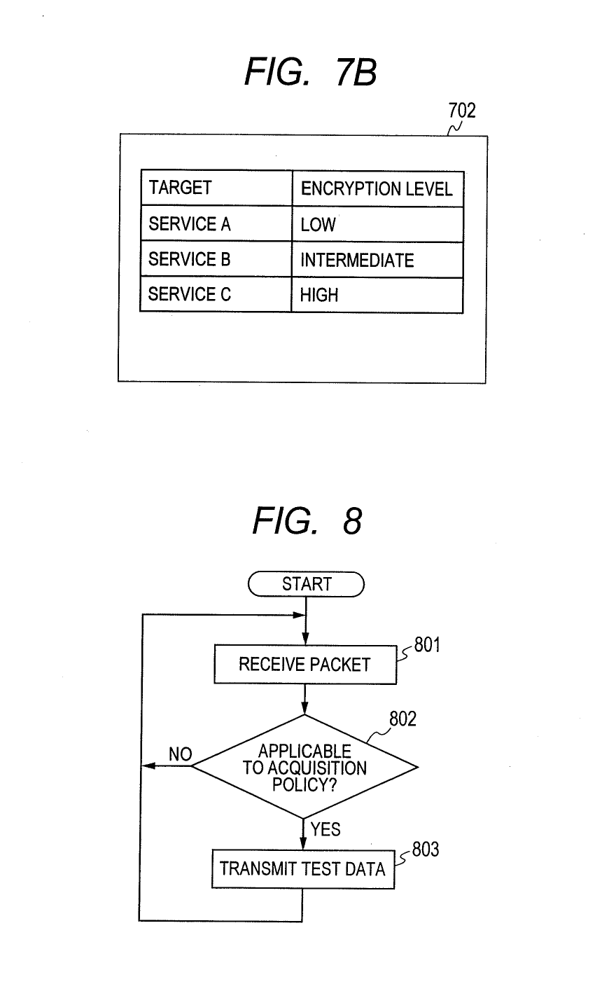

The test result display apparatus 103 receives the test result flowing on the communication path 107 and outputs the received test result onto a screen. The details of the test result screen will be discussed later in reference to FIGS. 7A and 7B. The test result display apparatus 103 displays the test result acquired by the encrypted traffic test apparatus 102. However, if the test result display apparatus 103 possesses sufficient capabilities, the apparatus 103 may also perform encrypted traffic tests in addition to receiving the test result from the communication path 107 and displaying the received test result.

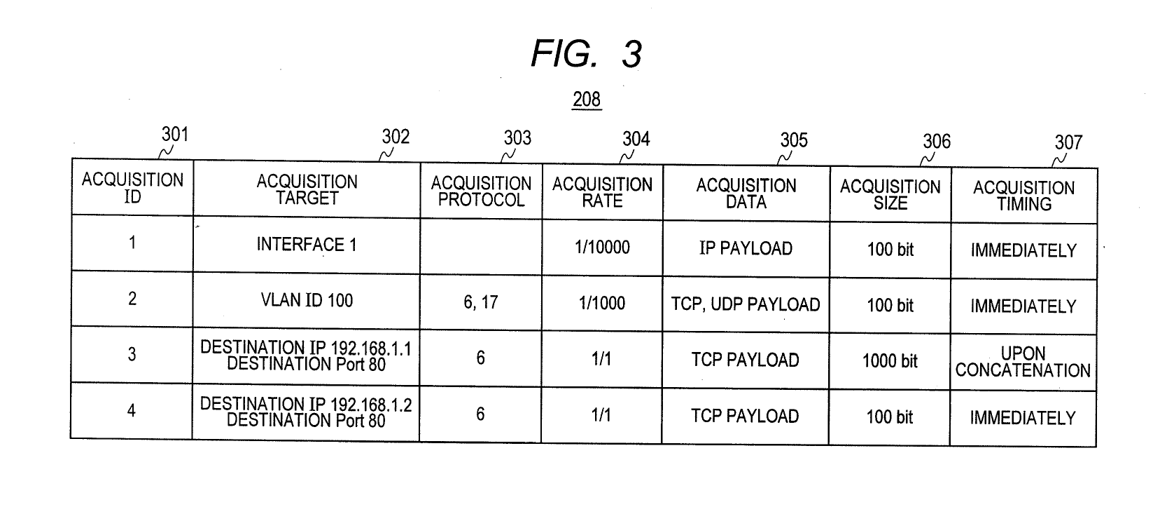

FIG. 2 shows a typical structure of the test data acquisition apparatus 101 that acquires test target data. For example, the test data acquisition apparatus 101 may be network equipment such as a router. The test data acquisition apparatus 101 may be a computer that includes a CPU (Central Processing Unit) 204, a memory 206 storing data necessary for the CPU 204 to perform its processing, a storage device 205 such as a hard disk or a flash memory large enough to accommodate masses of data, interfaces (IF) 201, 202 and 203; and a bus 207 that interconnects these components. In some other drawings, interfaces may also be referred to as a communication interface or an input/output interface depending on the destination to which the interface in question is connected; or as a communication apparatus, a reception apparatus, a transmission apparatus, or an input/output apparatus depending on the way the interface in question operates.

The CPU 204 acquires test data by executing a test data acquisition program 209 stored in the memory 206. The storage device 205 retains test data acquisition policy data 208 for selecting test target data.

The programs and data mentioned above may be held beforehand in the memory 206 or storage device 205, or may be installed (i.e., loaded) from another apparatus via the interface 201, 202 or 203 as needed.

FIG. 3 is a tabular view showing an example of the test data acquisition policy data 208. As shown in FIG. 3, the test data acquisition policy data 208 includes an acquisition ID 301, an acquisition target 302, an acquisition protocol 303, an acquisition rate 304, acquired data 305, an acquisition size 306, and an acquisition timing 307. The acquisition ID 301 represents information (identifier) for uniquely identifying each test data acquisition policy.

For example, the acquisition target 302 represents data for identifying a specific switch port or data for identifying the packets targeted to be acquired typically from communication with a specific terminal. The acquisition target protocol 303 is used to narrow down the packets applicable to the acquisition target 302. Specifically, the packets complying with the protocol designated as the acquisition target protocol 303 are regarded as the target to be acquired. If no acquisition target protocol 303 is designated, then all packets complying with any protocol are targeted to be acquired.

The acquisition rate 304 denotes the rate at which packets are to be sampled. If there are a large number of packets targeted to be acquired, the acquisition target rate 304 may be adjusted. For example, if the acquisition ID 301 in FIG. 3 is “1,” that means one out of 10,000 packets passing through “Interface 1” as the acquisition target 302 is to be acquired. The acquired data 305 represents data as the target to be acquired. For example, if “TCP payload” is designated as the acquired data 305, then the TCP payload part of the acquired packet is the target to be acquired. Although not shown in FIG. 3, if a range of 1 to 100 bytes of the TCP payload is designated, then the data in the designated range of the payload is targeted to be acquired. The acquisition size 306 denotes the size of the data to be acquired, and the acquisition timing 307 represents the timing for data acquisition. For example, if the acquisition timing 307 is designated as “immediately” and if the acquisition target data is larger than the data size designated as the acquisition size 306, then the acquired data is transmitted immediately onto the communication path 106 as test data. If the acquisition timing 307 is designated as “upon concatenation,” the data parts of subsequent packets are concatenated until they exceed the data size designated as the acquisition size 306, and then the concatenated data parts are transmitted onto the communication path 106 as test data. When the data parts of the subsequent packets are to be concatenated, the data parts are retained in the memory 206 or storage device 205 until they reach the data size designated as the acquisition size 306.

When the acquisition data is designated in detail as explained above, the unencrypted data parts such as packet headers are excluded from the tests. This makes it possible to improve the accuracy of the tests performed by the encrypted traffic test apparatus 102.

The test data acquisition program 209 is executed by the CPU 204. If the received packet applies to the acquisition target 302 and acquisition protocol 303 in the test data acquisition policy data 205, the test data acquisition program 209 thus executed acquires the test target data in accordance with the applicable acquisition rate 304, acquired data 305, acquisition size 306, and acquisition timing 307. The test data acquisition program 209 adds to the acquired test target data at least an acquisition ID 301 before transmitting the data as test data onto the communication path 106 via an interface 201. The test data transmitted onto the communication path 106 includes at least the acquisition ID 301 and the test target data. A specific process of the test data acquisition program 209 will be discussed later in reference to FIG. 8.

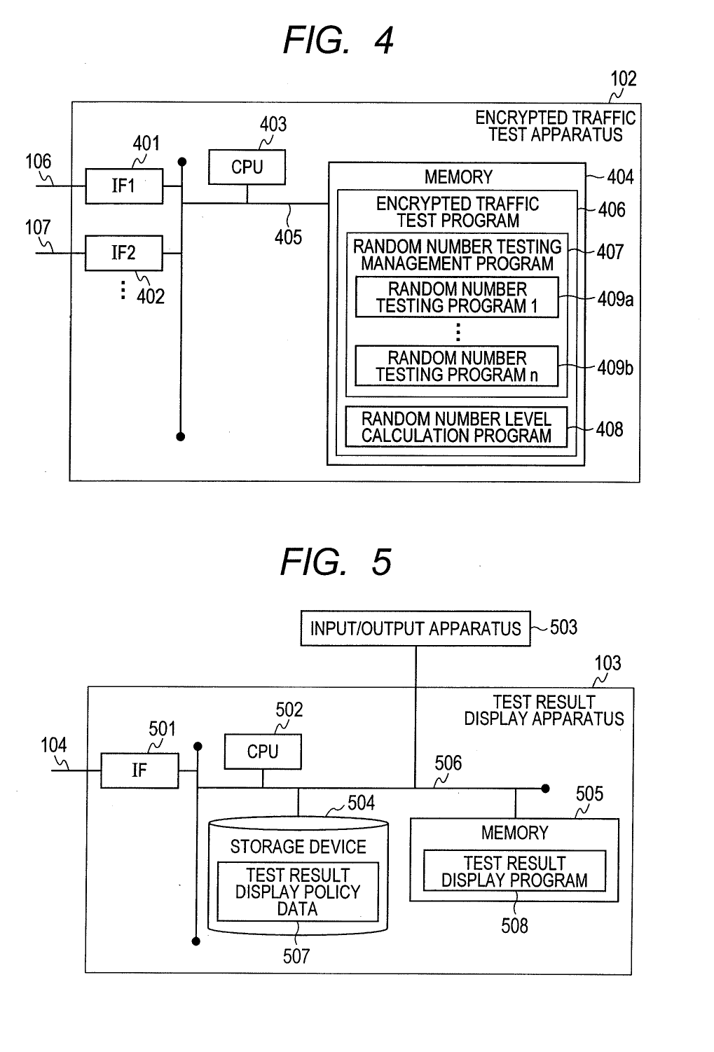

FIG. 4 shows a typical structure of the encrypted traffic test apparatus 102. As described above, the encrypted traffic test apparatus 102 performs encrypted traffic tests. The encrypted traffic test apparatus 102 is a computer structured to include a CPU 403, a memory 404, interfaces 401 and 402 for communicating with other apparatuses, and a communication path 405 interconnecting these components.

The CPU 403 performs encrypted traffic tests by executing an encrypted traffic test program 406 held in the memory 404. The encrypted traffic test program 406 is composed of a random number testing management program 407 and a random number level calculation program 408. The random number testing management program 406 includes at least one random number testing program 409. The random number testing program 409 is a program that determines whether or not given data is a random number using statistical techniques.

Each of the above-mentioned programs may be retained beforehand in the memory 404, or may be installed (i.e., loaded) from another apparatus via the interface 401 or 402.

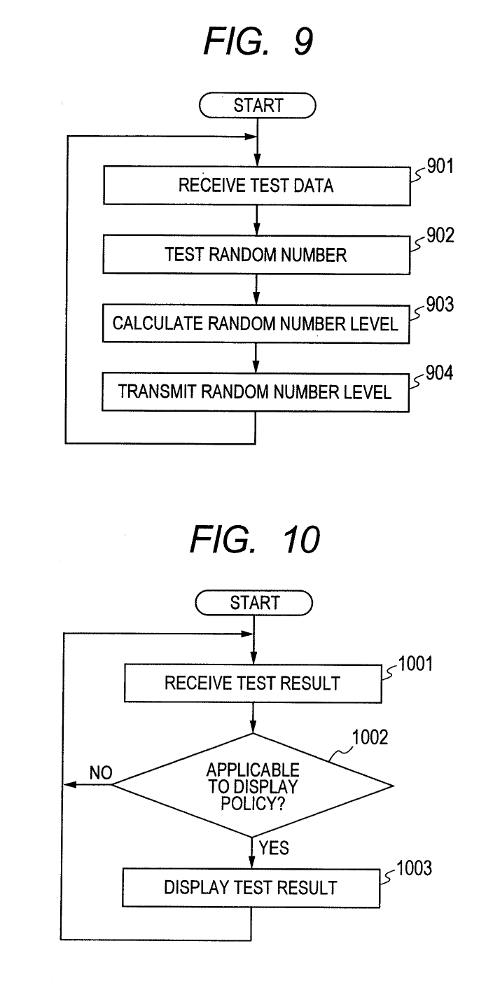

The encrypted traffic test program 406 is executed by the CPU 403. When executed, the encrypted traffic test program 406 tests whether or not received test data is encrypted and transmits the test result onto the communication path 107 via the interface 402. A specific process of the encrypted traffic test program 406 will be discussed later in reference to FIG. 9. The test result includes at least information representative of the acquisition ID 301 and a random number level. The random number level refers to how close the test data in question is to a true random number. For example, it may be assumed that the random number level ranges from 0 to 1 and that the smaller the value, the closer the data is to a true random number. On that assumption, if the random number level of given test data is smaller than a predetermined threshold value (e.g., 0.3), it may be determined that the test data in question is encrypted.

FIG. 5 shows a typical structure of the test result display apparatus 103. As described above, the test result display apparatus 103 displays test results. The test result display apparatus 103 is a computer structured to include a CPU 502, a memory 505, a storage device 504, an interface 501 for communicating with other apparatuses, an input/output apparatus 503 such as a keyboard and a display for effecting input and output, and a communication path 506 for interconnecting these components.

The CPU 502 displays test results by executing a test result display program 508 stored in the memory 505. The storage device 504 retains test result display policy data 507 for displaying the test results.

The programs mentioned above may be stored beforehand in the memory 505 or storage device 504, or may be installed (i.e., loaded) from the input/output apparatus 503 or another apparatus via the interface 501.

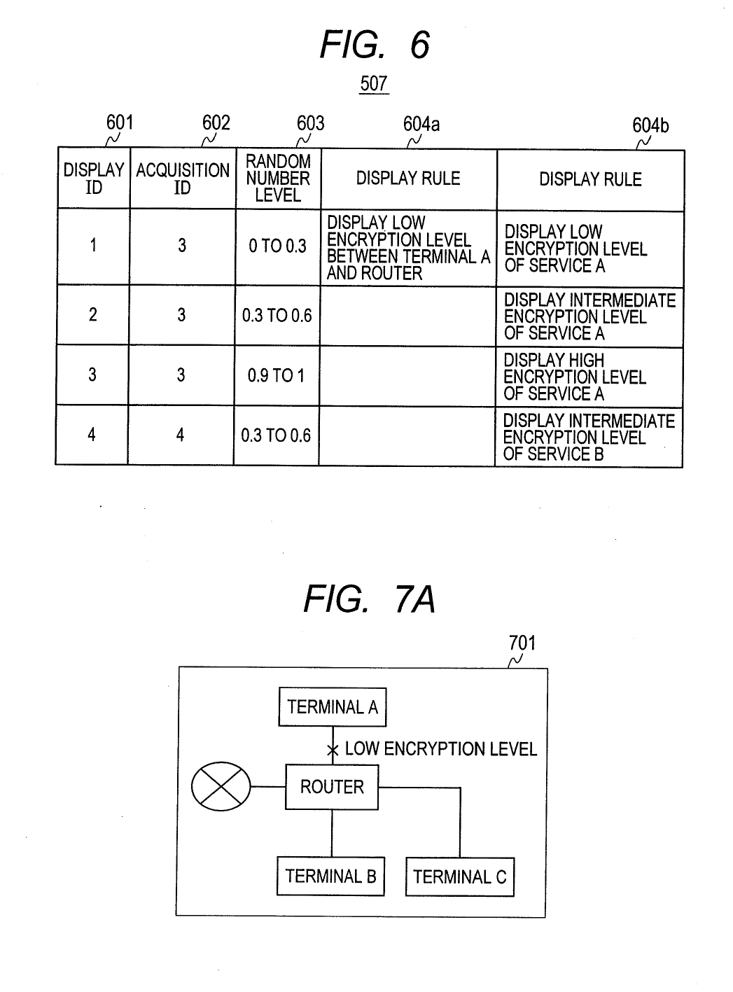

FIG. 6 is a tabular view showing an example of the test result display policy data 507. As shown in FIG. 6, the test result display policy data 507 constitutes information including a display ID 601, an acquisition ID 602, a random number level 603, and a display rule 604. The display ID 601 represents information (identifier) for uniquely identifying a test result display policy. The acquisition ID 602 indicates the acquisition policy according to which data is acquired, and holds the acquisition ID 301 that is part of the test data acquisition policy data 208 and included in the test result. The data corresponding to the acquisition ID 602 and random number level 603 is included in the test result transmitted by the encrypted traffic test apparatus 102. There are as many display rules 604 as the number of display screen modes provided corresponding to random number levels. The lower the random number level (i.e., the lower the possibility of encrypted traffic), the larger the number of display screen modes that should preferably be provided from diverse points of view in order to emphasize the warning. The display rule 604 describes the rule for giving screen display corresponding to the random number level received as part of the test result. For example, the display rule 604 may give display that traffic is cut off at the location targeted to be tested (with x superposed on the location), that the test target location has a particular random number level indicated by lines of varying thicknesses or colors, or that the encryption level of a given service (i.e., test target location) has dropped.

The test result display program 508 is executed by the CPU 502. When executed, the test result display program 508 displays the received test result on the screen. The details of a specific process by the test result display program 508 will be discussed later in reference to FIG. 10.

FIGS. 7A and 7B show typical test result display screens. For example, suppose that a terminal A (IP 192.168.1.1), a terminal B (IP 192.168.1.2) and a terminal C (IP 192.168.1.3) offer services A, B and C respectively through port No. 80 and that these terminals are connected to the Internet via a router. In this case, the display ID 601 designated as “1” may correspond to a test result display screen 701 in FIG. 7A and a test result display screen 702 in FIG. 7B. The test result display screen 701 shows that the randomness level between the terminal A and the router is low. The test result display screen 702 indicates that the encryption level of the service A is low.

Explained below is a process in which the test data acquisition program 209 of the test data acquisition apparatus 101 receives a packet and transmits test data (the process is called the acquisition process hereunder). FIG. 8 is a flowchart of the acquisition process.

As shown in FIG. 8, the test data acquisition program 209 for carrying out the test data acquisition process is executed by the CPU 204. When executed, the test data acquisition program 209 receives a packet via the interface 202 or 203 (in step 801). The program 209 references the header of the received packet to determine whether the packet is applicable to the acquisition target 302 of the test data acquisition policy data 208 (in step 802). If it is determined that the received packet applies to the acquisition target 302, the test data acquisition program 209 further determines whether the packet is applicable to the acquisition protocol 303. If the received packet is not applicable to at least one of the acquisition target 302 and acquisition protocol 303 (“don't care” if the acquisition protocol 303 is not designated), then control is returned to step 801.

If it is determined that the received packet applies to the acquisition target 302 and acquisition protocol 303, the test data acquisition program 209 selects test target data at the rate designated by the acquisition rate 304. However, if the received packet applies to the acquisition target 302 and if nothing is designated as the acquisition protocol 303, the test data acquisition program 209 selects the test target data from the data part of the received packet at the rate designated by the acquisition rate 304 regardless of the acquisition protocol type. The test data acquisition program 209 selects the data range designated by the acquired data 305 as the test target data. From the data selected as the test target data, the test data acquisition program 209 acquires the test data based on the acquisition size 306 and acquisition timing 307. Specifically, if the acquisition timing 307 is designated as “immediately” and if the size of the acquisition target data is larger than the acquisition size 306, the test data acquisition program 209 acquires the selected test target data as the test data. If the acquisition timing 307 is designated as “upon concatenation” and if the size of the acquired data is smaller than the acquisition size 306, then the test data acquisition program 209 concatenates the test target data of the subsequent packets until the test data exceeds the acquisition size 306.

The test data acquisition program 209 transmits the test data acquired in step 802 onto the communication path 106 via the interface 201 (in step 803). The test data acquisition program 209 performs the determination of whether the received packet applies to the test data acquisition policy data 208 in the order of acquisition IDs 301. Once the applicable acquisition ID 301 is found to exist, no further comparison will be made for the subsequent acquisition IDs 301.

The flow of the acquisition process in which test data is acquired from step 801 to step 803 is explained below using a specific example. If a TCP packet of which the destination IP is 192.168.1.1, the destination port is 80, and the size of the TCP payload is 2000 bits is received, the test data acquisition program 209 may compare the received packet with the acquisition target 302 of the test data acquisition policy data 208, for example. In this case, the packet in question applies to the acquisition target “destination IP 192.168.1.1, destination port 80” (302) of the acquisition ID “3” (301). This packet also applies to the acquisition protocol “6” (303) in the test data acquisition policy 208. Thus the packet in question is regarded as the target to be acquired as test data at the acquisition rate “1/1” (304). Next, the test data acquisition program 209 extracts the TCP payload designated by the acquired data “TCP payload” (305) from the packet and makes comparisons with the acquisition size “1000 bits” (306) and acquisition timing “upon concatenation” (307). Because the size of the TCP payload of the packet in question is 2000 bits exceeding the data size of 1000 bits, the test data acquisition program 209 transmits the acquisition ID “3” (301) of the test data acquisition policy data 208 and the TCP payload of the packet onto the communication path 106 as the test data via the interface 201.

Discussed below is a process in which the encrypted traffic test program 406 of the encrypted traffic test apparatus 102 receives test data and transmits the result of the test (the process is called the test process hereunder). FIG. 9 is a flowchart of the test process.

As shown in FIG. 9, the encrypted traffic test program 406 for carrying out the test process is executed by the CPU 403. When executed, the encrypted traffic test program 406 receives the test data flowing on the communication path 106 via the interface 401 (in step 901), and forwards the received test data to the random number testing management program 407. In turn, the random number testing management program 407 applies a plurality of random number testing programs 409 to the received test data (in step 902).

Each of the random number testing programs 409 incorporates a random number testing scheme for evaluating randomness. One such random number testing scheme may involve checking the deviation of data bit sequences. If given data is truly random, there is a high possibility that the number of “0” bits and that of “1” bits making up the data are the same or approximately the same. According to this scheme, the value of the number of “0” bits minus the number of “1” bits is divided by the value of the number of the “0” and “1” bits making up the data, and the absolute value of the resulting quotient is obtained. If the absolute value is smaller than a predetermined threshold value (e.g., 0.2), then it may be determined that the data is random (the threshold value may be varied according to circumstances).

The above-described random number testing scheme is only an example. The random number testing program 409 may alternatively incorporate the random number testing scheme described in NIST Special Publication 800-22, or some other suitable random number testing scheme. The random number testing management program 407 forwards to the random number level calculation program 408 the test results from these multiple random number testing programs 409.

Upon receipt of the results of random number testing from the random number testing management program 409, the random number level calculation program 408 calculates the random number level and transmits it to the encrypted traffic test program 406 (in step 903). A predetermined function may be used to calculate the random number level. For example, the random number level may be calculated as a weighted mean of the random number testing results obtained from a plurality of random number testing programs 409.

On receiving the random number level from the random number level calculation program 408, the encrypted traffic test program 406 transmits the acquisition ID 301 included in the test data received in step 901 along with the random number level calculated in step 903 as the test result onto the communication path 107 via the interface 402 (in step 904).

Described below is a process in which the test result display program 508 of the test result display apparatus 103 receives and displays test results (the process is called the display process hereunder). FIG. 10 is a flowchart of the display process.

As shown in FIG. 10, the test result display program 508 for carrying out the display process is executed by the CPU 502. When executed, the test result display program 508 receives the test result flowing on the communication path 107 via the interface 501 (in step 1001), and determines whether the acquisition ID and random number level included in the received test result apply to the acquisition ID 602 and random number level 603 of the test result display policy 507 (in step 1002). If it is determined that there is the applicable test result display policy, the test result display program 508 displays the test result on the input/output apparatus 503 in accordance with the display rule 604 of the applicable display policy (in step 1003), and returns to step 1001. The test result display program 508 performs the comparisons with the test result display policy data 507 in the order of display IDs 601. Once the applicable display ID 601 is found to exist, no further comparison will be made for the subsequent display IDs 601. Although it is explained above that the test result is displayed on the input/output apparatus 503, this is not limitative of the present invention. Alternatively, the test result may be displayed on an input/output apparatus of some other equipment after being forwarded thereto over the network.

The flow of the display process performed in step 1001 through step 1003 is explained below using a specific example. If the test result display program 508 receives the test result of which the acquisition ID is “3” and the random number level is “0.3,” then the applicable display policy may involve a display ID “1” (601), a display rule “Display low encryption level between terminal A and router,” and another display rule “Display low encryption level of service A,” for example.

As described, in the encrypted traffic test system for testing whether network traffic is encrypted, the test data acquisition apparatus 101 receives a packet over the network. From the packet received via the interface 202 or 203, the test data acquisition program 209 acquires test data in accordance with the test data acquisition policy data 208 and transmits the acquired test data via the interface 201. The encrypted traffic test apparatus 102 receives the test data from the test data acquisition apparatus 101 via the interface 401. Using a plurality of random number testing schemes, the encrypted traffic test program 406 tests the test data received via the interface 401 for randomness and calculates the random number level from the test result. The result of the test performed by the encrypted traffic test program 406 is transmitted via the interface 402 as the test result. The test result display apparatus 103 receives the test result from the encrypted traffic test apparatus 102 via the interface 501. The test result display program 508 selects the display rule in accordance with the test result received via the interface 501 and displays the test result accordingly. In this manner, each packet or each sequence of multiple packets is tested to determine whether or not encryption is in effect, and the test result is displayed in accordance with a predetermined display policy.

In other words, the first embodiment constitutes an encrypted traffic test system that identifies a test target packet or packets by referencing information included in the headers of the packets flowing over the network, evaluates the randomness of the payload of each test target packet identified, and considers any test target packet with a randomness level lower than a predetermined threshold value to be an unencrypted packet.

The first embodiment may be partially modified as follows: the test data acquisition program 209 may be modified so as to acquire the test data from the data held in the memory 206 or storage device 205. This makes it possible to test whether or not the data retained in the memory or storage device is encrypted. The result may prompt the system administrator to take appropriate measures such as execution of encryption.

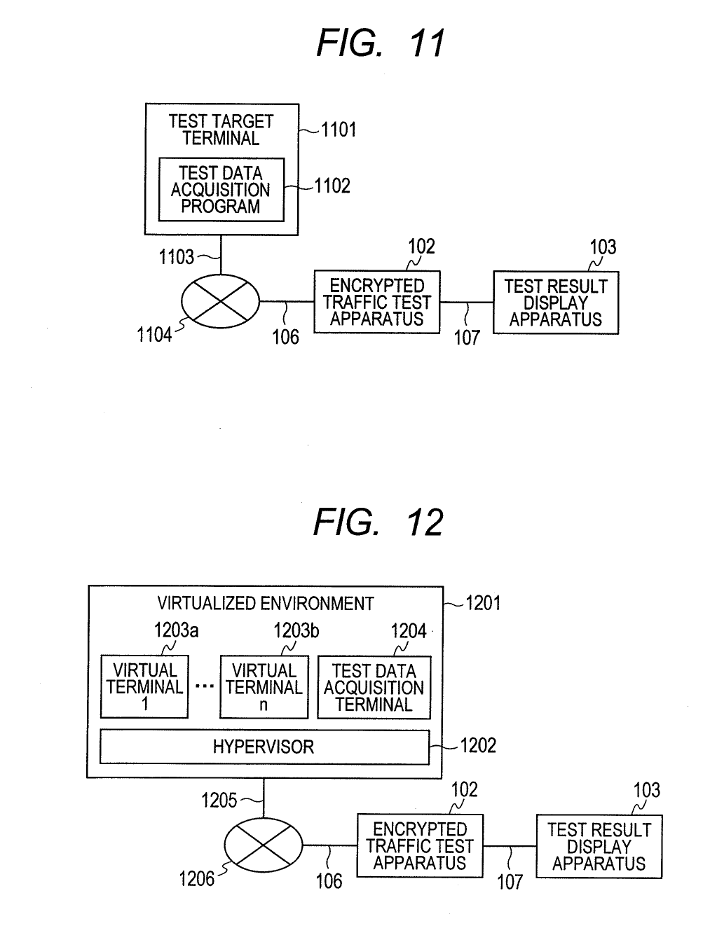

In another modification, as shown in FIG. 11, a test data acquisition program 1102 having the capabilities equivalent to those of the test data acquisition apparatus 101 may be installed (i.e., loaded) into a test target terminal 1101. This limits the test target to the traffic involving the test target terminal 1101 alone, which alleviates the testing load on the encrypted traffic test apparatus 102.

In a further modification, as shown in FIG. 12, a test data acquisition terminal 1204 may be set up on a hypervisor 1202 of a virtualized environment. This makes it possible to test the traffic of other virtual terminals 1203 set up on the hypervisor 1202.

### Second Embodiment

The second embodiment of the present invention is an encrypted traffic test system that includes the encrypted traffic test system of the first embodiment and is designed further to take countermeasures corresponding to the test result.

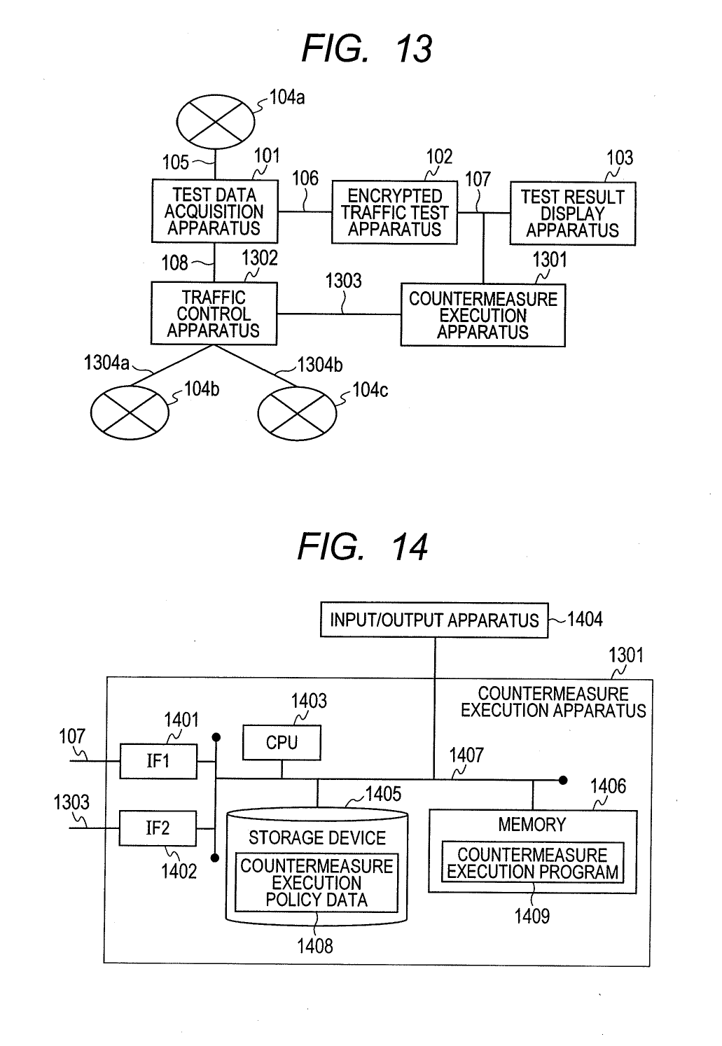

FIG. 13 is a schematic view showing a typical network configuration including the encrypted traffic test system as the second embodiment. In the description that follows, the components substantially the same as those of the first embodiment are designated by like reference characters, and their explanations will be omitted where redundant. The ensuing description of the second embodiment will center on what is different from the first embodiment.

As shown in FIG. 13, the encrypted traffic test system of the second embodiment is structured to include the above-described encrypted traffic test system of the first embodiment, a countermeasure execution apparatus 1301, and a traffic control apparatus 1302.

In the ensuing description, transmission of traffic control commands and control of the traffic will be shown to be performed by the relevant apparatuses mentioned above. Alternatively, however, traffic control may be carried out by a single apparatus depending on the traffic flowing on the network. First to be explained is the countermeasure execution apparatus 1301.

FIG. 14 shows a typical structure of the countermeasure execution apparatus 1301 that receives test results and transmits traffic control commands. The countermeasure execution apparatus 1301 is a computer that includes a CPU 1403, a memory 1406, a storage device 1405, an input/output apparatus 1404, interfaces 1401 and 1402, and a communication path 1407 interconnecting these components.

The CPU 1403 transmits traffic control commands by executing a countermeasure execution program 1409 held in the memory 1406. The storage apparatus 1405 holds countermeasure execution policy data 1408 for controlling the traffic.

The programs and data mentioned above may be held beforehand in the memory 1406 or storage device 1405, or may be installed (i.e., loaded) from another apparatus via the input/output apparatus 1404 or interface 1401 or 1402 as needed.

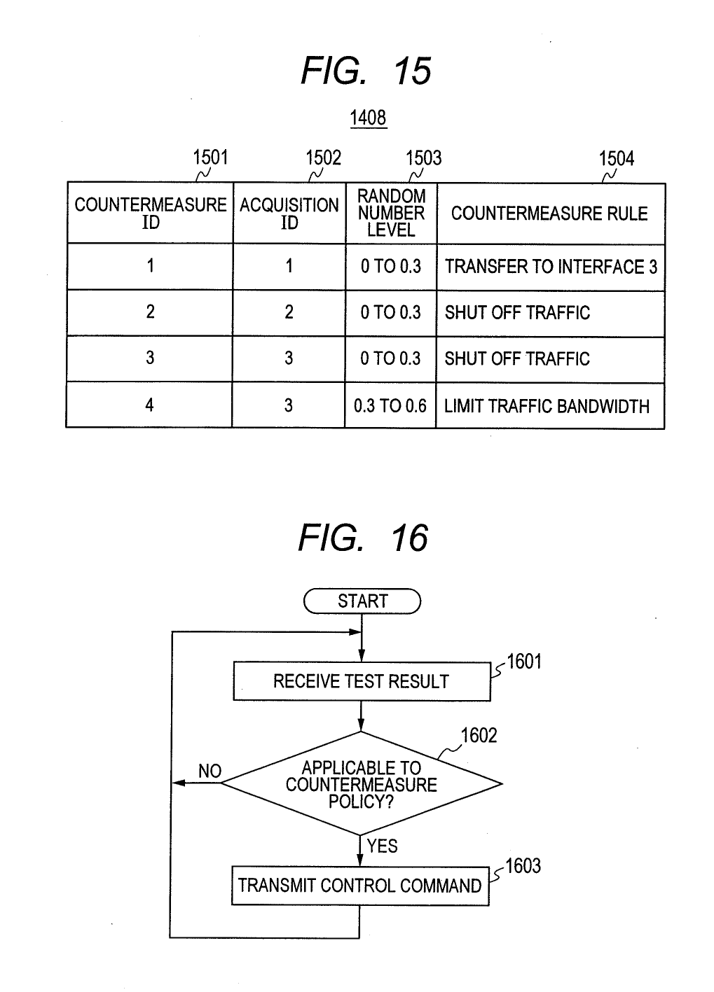

FIG. 15 is a tabular view showing an example of the countermeasure execution policy data 1408. As shown in FIG. 15, the countermeasure execution policy data 1408 includes a countermeasure ID 1501, an acquisition ID 1502, a random number level 1503, and a countermeasure rule 1504. The countermeasure ID 1501 represents information (i.e., identifier) for uniquely identifying a countermeasure execution policy. The acquisition ID 1502 denotes the acquisition policy according to which test data is acquired. As such, the acquisition ID 1502 accommodates the acquisition ID 301 of the test data acquisition policy data 208. The acquisition ID 1502 and random number level 1503 are information included in the test result transmitted by the encrypted traffic test apparatus 102. The countermeasure rule 1504 represents a traffic control rule. For example, the traffic control rules may include discarding of packets, limiting of the bandwidth so as to restrict the amount of traffic (i.e., packet count) per unit time, and changing of the destination for packets.

The countermeasure execution program 1409, executed by the CPU 1403, compares the received test result with the countermeasure execution policy data and transmits a traffic control command onto the communication path 1303 via the interface 1402. A detailed process performed by the countermeasure execution program 1409 will be discussed later in reference to FIG. 16.

The traffic control apparatus 1302 is an apparatus that receives traffic control commands and controls accordingly the traffic passing therethrough. For example, the traffic controls may include discarding of packets, limiting of the bandwidth, and changing of the destination for packets as mentioned above. For example, the traffic control apparatus 1301 may be implemented by common network equipment such as a router so that the structure thereof will not be included in the appended drawings.

Explained below is a process in which the countermeasure execution program 1409 of the countermeasure execution apparatus 1301 receives test results and transmits traffic control commands accordingly (the process is called the control process hereunder). FIG. 16 is a flowchart of the control process.

As shown in FIG. 16, the countermeasure execution program 1409 for carrying out the control process is executed by the CPU 1403. When executed, the countermeasure execution program 1409 receives the test result flowing on the communication path 107 via the interface 1401 (in step 1601), and determines whether the acquisition ID and random number level included in the received test result apply to the acquisition ID 1502 and random number level 1503 in the countermeasure execution policy data 1408 (in step 1602). If it is determined that the applicable countermeasure execution policy exists, the countermeasure execution program 1409 conforming to the countermeasure rule 1504 of the applicable countermeasure execution policy transmits the countermeasure rule in question as a control command onto the communication path 1303 via the interface 1402 (in step 1603), and returns to step 1601. The countermeasure execution program 1409 performs the comparisons with the countermeasure execution policy data 1408 in the order of countermeasure IDs 1501. Once the applicable countermeasure ID 1501 is found to exist, no further comparison will be made for the subsequent countermeasure IDs 1501.

The flow of the control process performed in step 1601 through step 1603 is explained below using a specific example. If the countermeasure execution program 1409 receives via the interface 1401 the test result of which the acquisition ID is “3” and the random number level is “0.3,” then the applicable countermeasure execution policy in the countermeasure execution policy data 1408 may be “Shut off traffic” corresponding to the countermeasure ID “3” (1501), for example.

With the second embodiment, as described above, the countermeasure execution apparatus 1301 receives via the interface 1401 the test result transmitted by the encrypted traffic test apparatus 102. From the test result thus received through the interface 1401, the countermeasure execution program 1409 selects the countermeasure rule in accordance with the countermeasure execution policy and transmits the selected countermeasure rule as a traffic control command via the interface 1401. Upon receipt of the control command, the traffic control apparatus 1303 controls the traffic accordingly to test whether each test target is encrypted. Thus the second embodiment permits traffic control based on the countermeasure execution policy.

The second embodiment may be partially modified as follows: a countermeasure rule for indirectly prompting the execution of traffic control instead of exercising direct traffic control may be incorporated in the countermeasure rule 1504 of the countermeasure execution policy data 1408. For example, the added rule may cause a warning message to be displayed on the input/output apparatus 1404 or a warning mail to be transmitted to the system administrator. This in turn prompts the administrator to take necessary measures quickly.

### Third Embodiment

The third embodiment of the present invention is an encrypted traffic test system that includes the encrypted traffic test system of the first embodiment and is designed further to store test results.

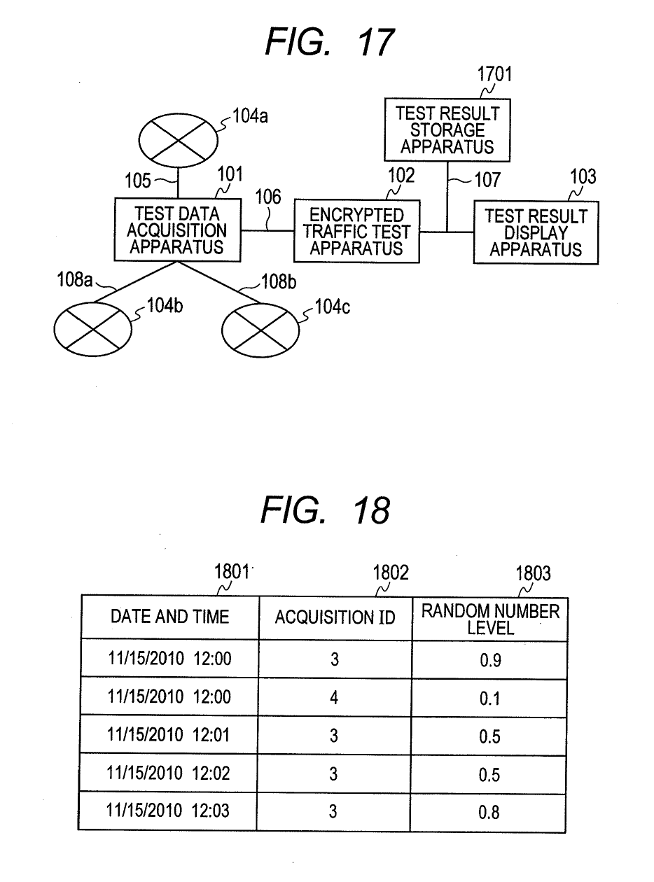

FIG. 17 is a schematic view showing a typical network configuration including the encrypted traffic test system as the third embodiment. In the description that follows, the components substantially the same as those of the first embodiment are designated by like reference characters, and their explanations will be omitted where redundant. The ensuing description of the third embodiment will center on what is different from the first embodiment.

As shown in FIG. 17, the encrypted traffic test system of the third embodiment is structured to include the above-explained encrypted traffic test system of the first embodiment and a test result storage apparatus 1701.

The test result storage apparatus 1701 is an apparatus that contains a storage device for receiving test results and storing the received test results. For example, the test result storage apparatus 1701 may be implemented by a common computer so that the structure thereof will not be included in the appended drawings.

The ensuing description will show how test results are stored into the test result storage apparatus 1701. Depending on the frequency with which test results are received, the test result storage apparatus 1701 may be integrated with the encrypted traffic test apparatus 102 or with the test result display apparatus 103 in a single apparatus, for example.

FIG. 18 is a tabular view showing an example of test result data. As shown in FIG. 18, the test result data includes a date and time 1801, an acquisition ID 1802, and a random number level 1803. The date and time 1801 represents the date and the point in time at which the test result storage apparatus 1701 receives a given test result. The acquisition ID 1802 denotes the acquisition policy according to which the test result is acquired. The acquisition ID 1802 is composed of the acquisition ID 301 of the test data acquisition policy data 208 as part of the test data. As such, the acquisition ID 1802 along with the random number level 1803 is included in the test result transmitted by the encrypted traffic test apparatus 102.

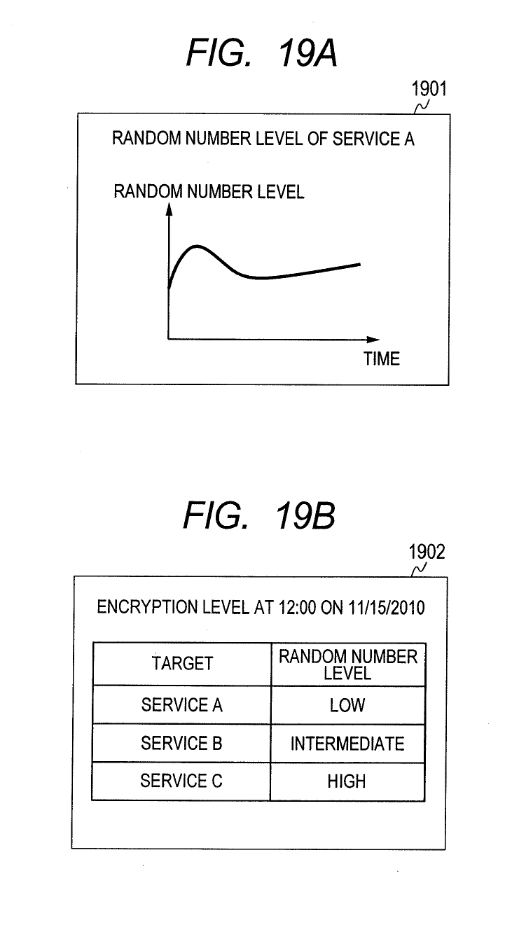

FIGS. 19A and 19B show typical test result display screens on which test results are displayed by the test result display program 508 of the test result display apparatus 103 through the use of the test result data stored in the test result storage apparatus 1701. A test result display screen 1901 in FIG. 19A shows how the random number level of service A has changed over time. A test result display screen 1902 in FIG. 19B indicates the random number levels of various services at a given point in time in the past.

With the third embodiment, as mentioned above, the test result display program 508 acquires test data by accessing the test result storage apparatus 1701 periodically or as needed via the interface 501, and displays the test result display screens accordingly.

According to the third embodiment, as described above, the test result storage apparatus 1701 receives the test results transmitted by the encrypted traffic test apparatus 102 and places the received test results into a storage device. The test result display apparatus 103 displays the test result display screens using the test results retrieved from the test result storage apparatus 1701. The third embodiment thus makes it possible to display past test results on a time-series basis or the test results in effect at a given point in time in the past.

According to the encrypted traffic test system discussed above, it is possible to test whether or not each target of traffic on a network is encrypted.

The embodiments and their modifications described above are merely examples in which the present invention may be implemented. These embodiments and their modifications and other examples of the present invention are not limitative thereof, and it should be understood by those skilled in the art that various modifications, combinations, sub-combinations and alterations of the components constituting the present invention may occur depending on design requirements and other factors in so far as they are within the scope of the appended claims or the equivalents thereof.

What is claimed is:

1. An encrypted traffic test system for testing whether or not traffic involving packets over a network is encrypted, the encrypted traffic test system comprising:
a test data acquisition portion configured to receive each of the packets on the network so as to acquire test data from the received packet;
an encrypted traffic test portion configured to evaluate the test data acquired by the test data acquisition portion for randomness using a random number testing scheme and, if the test data is evaluated to have randomness, to further determine that the traffic involving the packets including the test data is encrypted traffic; and
a test result display portion configured to display a test result from the encrypted traffic test portion on a test result display screen.

2. The encrypted traffic test system according to claim 1, wherein, if the received packet is determined to be part of the traffic communicating with a predetermined target under a predetermined communication protocol, the test data acquisition portion acquires the test data from the received packet in accordance with a predetermined sampling rate, a predetermined test target data part, a predetermined acquisition size, and a predetermined acquisition timing.

3. The encrypted traffic test system according to claim 1, wherein the test data acquisition portion adds, to the test data, information for identifying the test data before outputting the test data to the encrypted traffic test portion.

4. The encrypted traffic test system according to claim 1, wherein the encrypted traffic test portion tests randomness using at least the one random number testing scheme and evaluates the randomness based on a test result of at least the one random number testing scheme.

5. The encrypted traffic test system according to claim 1, wherein the encrypted traffic test portion outputs the test result including information for identifying the test data and information indicative of a random number level of the test data; and
wherein the test result display portion gives a display based on the test result output by the encrypted traffic test portion.

6. The encrypted traffic test system according to claim 5, further comprising a countermeasure execution portion configured to transmit a control command for controlling the traffic involving the packets based on the test result output by the encrypted traffic test portion.

7. The encrypted traffic test system according to claim 5, further comprising a test result storage portion configured to store the test result output by the encrypted traffic test portion and a date and time at which the test result is received.
